(19) United States
(12) Patent Application Publication
(10) Pub. No.: US 2019/0255628 A1
(43) Pub. Date: Aug. 22, 2019

(54) CUTTING TOOL INSERT

(71) Applicant: KYOCERA CORPORATION, Kyoto-shi, Kyoto (JP)

(72) Inventor: Shosei GOTO, Koka-shi, Shiga (JP)

(21) Appl. No.: 16/088,841

(22) PCT Filed: Mar. 27, 2017
(86) PCT No.: PCT/JP2017/012396

§ 371 Date: Sep. 27, 2018

(30) Foreign Application Priority Data
Mar. 28, 2016 (JP) 2016-064249

(51) Int. Cl. B23C 5/20; B23C 5/10; B23C 5/08

(52) U.S. Cl. CPC B23C 5/205; B23C 5/109; B23B 27/145; B23C 2200/125; B23C 2200/205; B23C 5/08

(57) ABSTRACT

An insert includes a first part and a second part. The first part includes a first surface, a second surface, and a plurality of side surfaces located between the first surface and the second surface. The second part includes a third surface, a fourth surface, and a first cutting edge. The third surface is located between the side surfaces and located from a side of the first surface to a side of the second surface. The fourth surface is located between the side surfaces and adjacent to the third surface. The first cutting edge is located along at least a part of a ridge line of the third surface and the fourth surface. The first cutting edge is inclined in a front view of the third surface, and the first cutting edge has a convex curvilinear shape in a front view of the fourth surface.

### CROSS-REFERENCE TO RELATED APPLICATIONS

This application is a national stage entry according to 35 U.S.C. 371 of PCT Application No. PCT/JP2017/012396 filed on Mar. 27, 2017, which claims priority to Japanese Application No. 2016-064249 filed on Mar. 28, 2016, which are entirely incorporated herein by reference.

### TECHNICAL FIELD

The disclosure relates to an insert for a cutting tool used in a grooving process or the like. An example of the grooving process includes a slot process.

### BACKGROUND

A cutting tool including an insert is used when a cutting process of a workpiece is carried out to manufacture a machined product. WO2012/173255 (Patent Document 1) describes a rotary cutting tool used in the slot process that is an example of cutting processes.

An insert described in Patent Document 1 includes an insert body and a plurality of protrusions. Each of the protrusions includes an inclined straight-line shaped cutting edge in an intersection part of a flat end surface (protrusion-side end surface) and a flat side surface (protrusion side surface).

With the configuration that the straight-line shaped cutting edge is inclined, a bottom surface of a groove may protrude in a convex shape during the slot process. This seems to be because a rotational track of the cutting edge forms a straight-line shape but a circular arc shape during the slot process.

A non-limiting aspect of the disclosure may aim at providing an insert with which the bottom surface of the groove is less likely to protrude.

### SUMMARY

An insert for a cutting tool in a non-limiting aspect of the disclosure includes a first part and a second part. The first part includes a first surface, a second surface located at an opposite side of the first surface, and a plurality of side surfaces located between the first surface and the second surface. The second part includes a third surface, a fourth surface, and a first cutting edge. The third surface is located between the plurality of side surfaces and located from a side of the first surface to a side of the second surface. The fourth surface is located between the plurality of side surfaces and adjacent to the third surface. The first cutting edge is located along at least a part of a ridge line of the third surface and the fourth surface. The first cutting edge is inclined so as to approach a center of the second surface as going toward an end portion at a side of the second surface in a front view of the third surface. The first cutting edge has a convex curvilinear shape in a front view of the fourth surface.

### BRIEF DESCRIPTION OF THE DRAWINGS

FIG. 1 is a perspective view of a side of a first surface illustrating a non-limiting aspect of an insert;

FIG. 2 is a perspective view of a side of a second surface in the insert illustrated in FIG. 1;

FIG. 3 is a front view of the first surface in the insert illustrated in FIG. 1;

FIG. 4 is a front view of the second surface in the insert illustrated in FIG. 1;

FIG. 5 is a side view as viewed from A1 direction in the insert illustrated in FIG. 4;

FIG. 6 is a side view as viewed from A2 direction in the insert illustrated in FIG. 4;

FIG. 7A is a schematic diagram illustrating a rotational track in a cutting edge having a straight-line shape, FIG. 7B is a schematic diagram illustrating a rotational track of the cutting edge as viewed from an arrow X direction in FIG. 7A, and FIG. 7C is a sectional view illustrating a machined groove after a slot process is carried out using the cutting edge having the straight-line shape;

FIG. 8 is an enlarged view of a cross section taken along line B1-B1 in the insert illustrated in FIG. 4;

FIG. 9 is an enlarged view of a region C1 in the insert illustrated in FIG. 6;

FIG. 10 is a sectional view taken along line B2-B2 in the insert illustrated in FIG. 9;

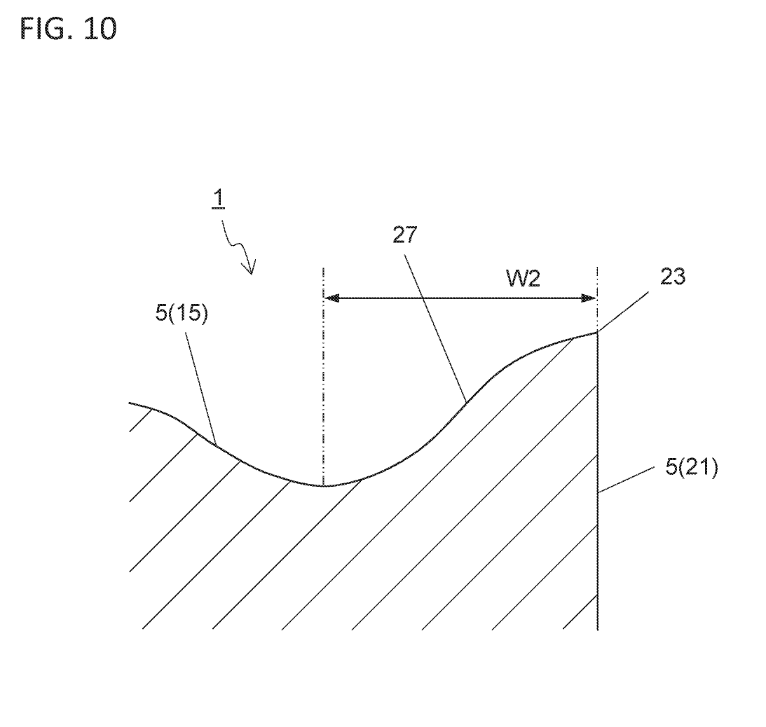

FIG. 11 is a sectional view taken along line B3-B3 in the insert illustrated in FIG. 9;

FIG. 12 is a perspective view illustrating a non-limiting aspect of a cutting tool;

FIG. 13 is an enlarged view of a region C2 in the cutting tool illustrated in FIG. 12;

FIG. 14 is a perspective view illustrating a non-limiting aspect of a holder;

FIG. 15 is an enlarged view of a region C3 in the cutting tool illustrated in FIG. 14;

FIG. 16 is a front view in the cutting tool illustrated in FIG. 12;

FIG. 17 is an enlarged view of a region C4 in the cutting tool illustrated in FIG. 16;

FIG. 18 is a side view taken from A3 direction in the cutting tool illustrated in FIG. 12;

FIG. 19 is an enlarged view of a region C5 in the cutting tool illustrated in FIG. 18;

FIG. 20 is a schematic diagram illustrating a step in a method of manufacturing a machined product;

FIG. 21 is a schematic diagram illustrating a step in a method of manufacturing a machined product; and

FIG. 22 is a schematic diagram illustrating a step in a method of manufacturing a machined product.

### DETAILED DESCRIPTION

An insert 1 in a non-limiting aspect of the disclosure is described in detail below with reference to the drawings. For the sake of description, the drawings referred to in the following illustrate, in a simplified form, only main members necessary for describing the aspects of the disclosure. The insert is therefore capable of including any arbitrary structural member not illustrated in the drawings referred to. Sizes of the members in each of the drawings do not faithfully represent sizes and size ratios of actual structural members.

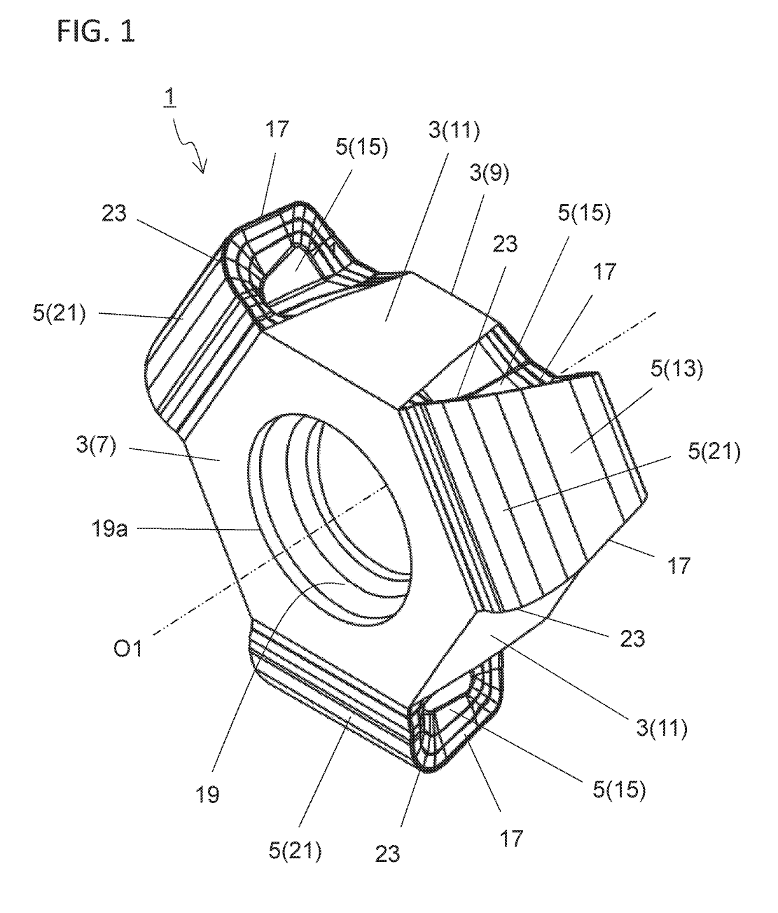

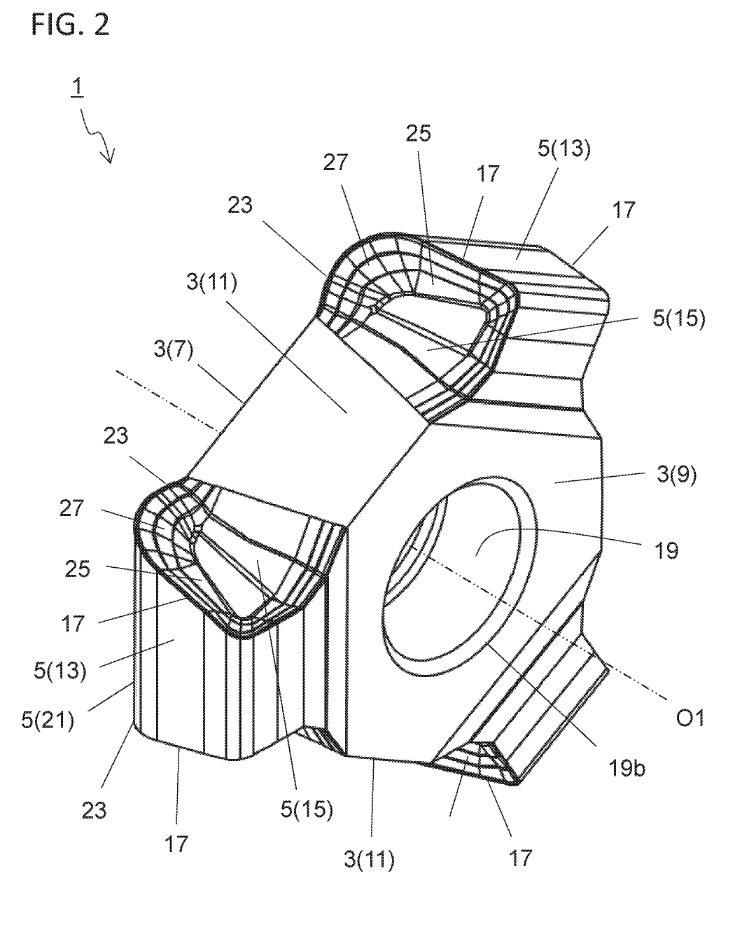

The insert 1 of the present non-limiting aspect of the disclosure includes a planar shape as a whole, and includes a first part 3 and a second part 5 as illustrated in FIGS. 1 and 2. The insert 1 may be configured to include only one second part 5 or a plurality of the second parts 5. In the configuration including the plurality of second parts 5, no specific limit is imposed on the number of the second parts 5. The insert 1 includes three second parts 5 in the present. non-limiting aspect of the disclosure.

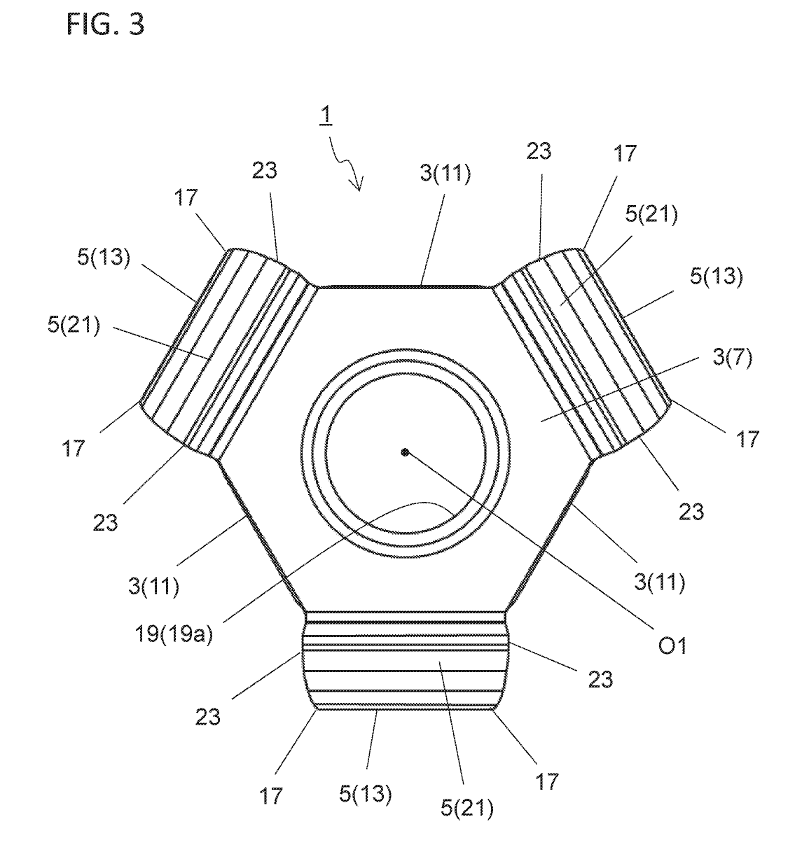

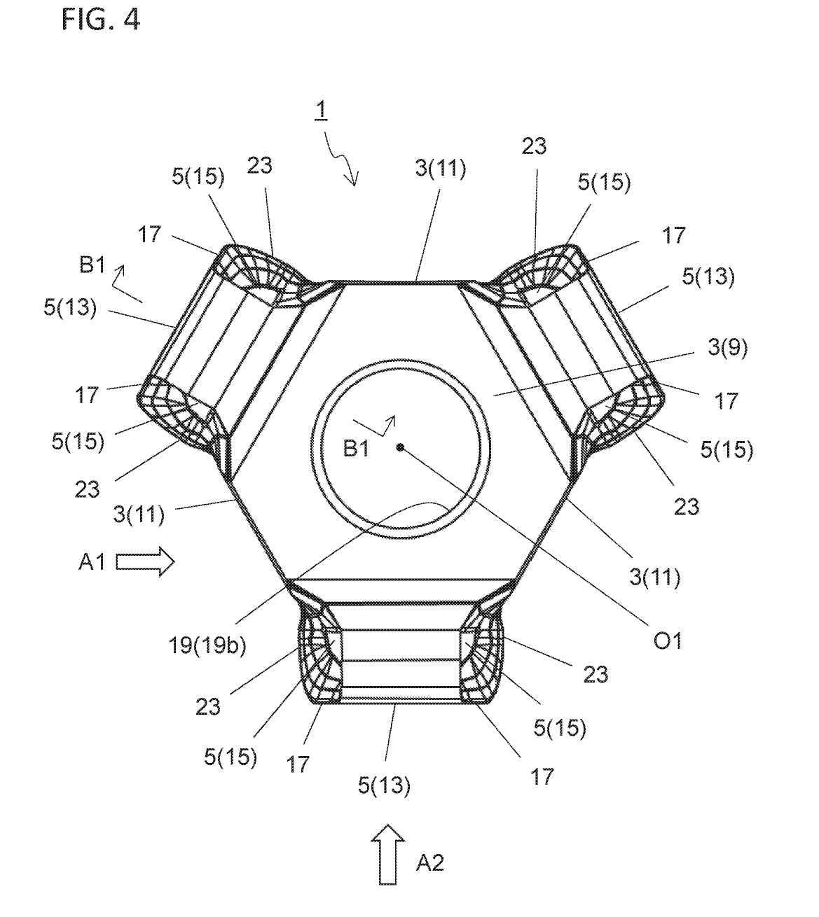

Specifically, as illustrated in FIGS. 3 and 4, the insert 1 in the present non-limiting aspect of the disclosure has such an approximately triangular plate shape that the first part 3 is located centrally and the second parts 5 are respectively located at three corners. Here, as a size of the insert 1 having the approximately triangular plate shape, for example, a length of one side of a triangle is settable to 5-20 mm. A thickness of the insert 1 is settable to 1-4 mm.

The first part 3 and the second parts 5 are integrally formed in the insert 1 of the present non-limiting aspect of the disclosure. Alternatively, the first part 3 and the second parts 5 may be formed separately and then joined together. For example, cemented carbide or cermet is usable as a material of the insert 1.

Examples of compositions of the cemented carbide include WC-Co, WC-TiC-Co, and WC-TiC-TaC-Co. Here, WC (tungsten carbide), TiC (titanium carbide), and Tac (tantalum carbide) are hard particles, and Co (cobalt) is a binding phase.

The cermet is a sintered composite material obtained by compositing metal into a ceramic ingredient. A specific example of the cermet is a titanium compound composed mainly of TiC or TiN (titanium nitride).

A surface of the insert 1 may be coated with a coating film by using chemical vapor deposition (CVD) method or physical vapor deposition (PVD) method. As a composition of the coating film, there are, for example, TiC, TiN, TiCN (titanium carbonitride), and alumina (Al₂O₃).

As illustrated in FIGS. 1 and 2, the first part 3 includes a first surface 7, a second surface 9, a plurality of side surfaces 11, and a central axis O1. The first part 3 is located at a middle part of the insert 1. The second part 5 includes a third surface 13, a fourth surface 15, and a first cutting edge 17. The second part 5 is located at an outer peripheral side of the insert 1 with respect to the first part 3, and located at a part of a circumferential edge of the insert 1.

The first part 3 has an approximately flat plate shape and includes relatively large two surfaces and a small width surface located between the two surfaces. The relatively large surfaces are the first surface 7 and the second surface 9 in the present non-limiting aspect of the disclosure. The first surface 7 and the second surface 9 have a polygonal shape, and the second surface 9 is located at the opposite side of the first surface 7. Surfaces located between the first surface 7 and the second surface 9 are the plurality of side surfaces 11.

The term “polygonal shape” does not mean a strict polygonal shape. For example, the first surface 7 and the second surface 9 may have a shape whose corners are cut away. The shape of each of sides of the first surface 7 and the second surface 9 is not limited to a strict straight-line shape. The first surface 7 and the second surface 9 have an approximately hexagonal shape obtained by cutting away three corners of the triangle in the present non-limiting aspect of the disclosure.

Because the insert 1 of the present non-limiting aspect of the disclosure also includes the second parts 5 in addition to the first part 3, the plurality of side surfaces 11 of the first part 3 are located at portions on an entire outer peripheral surface of the insert 1 except for the second parts 5. Therefore, the side surfaces 11 of the first part 3 in the present non-limiting aspect of the disclosure are not formed in an annular shape but are made up of a plurality of separate parts.

The central axis O1 is located so as to pass through the center of the first surface 7 and the center of the second surface 9. The insert 1 of the present non-limiting aspect of the disclosure has a rotational symmetric shape around the central axis O1. The first part 3 therefore has a rotational symmetric shape around the central axis O1. Specifically, the first part 3 has a 120°-rotational symmetric shape around the central axis O1.

The first part 3 in the present non-limiting aspect of the disclosure includes a through hole 19 that opens into the first surface 7 and the second surface 9. An opening portion of the first surface 7 is referred to as a first open region 19a, and an opening portion of the second surface 9 is referred to as a second open region 19b.

The through hole 19 is used for fixing the insert 1 to a holder. For example, the insert 1 is fixable to the holder by inserting a screw from the second open region 19b of the through hole 19, and by engaging the screw into a screw hole formed in the holder. The insert 1 is detachable from the holder by disengaging the screw. Thus, because the first part 3 in the insert 1 is a part restrained to the holder, the first part 3 is also called a restraining part in the insert 1.

The first open region 19a is located at a middle part of the first surface 7, and the second open region 19b is located at a middle part of the second surface 9 in the present non-limiting aspect of the disclosure. An axis of the through hole 19 therefore coincides with the central axis O1.

The insert 1 of the present non-limiting aspect of the disclosure includes the three second parts 5. The insert 1 has the rotational symmetric shape around the central axis O1 in the present non-limiting aspect of the disclosure. Therefore, when the insert 1 is rotated 120° on the basis of the central axis O1, one of the three second parts 5 is overlapped with another of the second parts 5. One of the three second parts 5 is described below, and a description of the other two second parts 5 is omitted here.

The second part 5 is located more toward an outer peripheral side than the first part 3, and includes the third surface 13 and the fourth surface 15. The third surface 13 and the fourth surface 15 are surfaces located at the second part 5 on an outer peripheral surface of the entirety of the insert 1. The third surface 13 and the fourth surface 15 are therefore respectively adjacent to the plurality of side surfaces 11 in the first part 3. Here, the fourth surface 15 connects to the plurality of side surfaces 11 in the first part 3. The third surface 13 intersects with the fourth surface 15, and the first cutting edge 17 is located along at least a part of an intersection part of the third surface 13 and the fourth surface 14.

The first cutting edge 17 is a part used for cutting out a workpiece during a cutting process. Because the insert 1 of the present non-limiting aspect of the disclosure includes the three second parts 5, there are at least three first cutting edges 17. The three first cutting edges 17 are not used at the same time during the cutting process of the workpiece. Any one of the three first cutting edges 17 is used for a single cutting process. Thus, the second parts 5 in the insert 1 are parts used for the cutting process, and the second parts 5 are therefore also called cutting parts in the insert 1.

When the first cutting edge 17 in the insert 1 of the present non-limiting aspect of the disclosure deteriorates due to a long time cutting process, the insert 1 needs to be temporarily detached from the holder and then attached again to the holder by changing the direction of the insert 1. Thus, other first cutting edges 17 not being used is usable for the cutting process.

A so-called honing process may be applied to the intersection part of the third surface 13 and the fourth surface 15, along which the first cutting edge 17 is formed. In other words, an intersection ridge line of the third surface 13 and the fourth surface 15 need not be a strict line shape formed by the intersection of the two surfaces. When this part has the line shape, the strength of the first cutting edge 17 becomes lower. The intersection part of the third surface 13 and the fourth surface 15 may be subjected to a round honing process by which this part is formed into a curved surface shape.

A rake surface is located at one of the third surface 13 and the fourth surface 15, and a flank surface is located at the other of the third surface 13 and the fourth surface 15. The third surface 13 includes the flank surface and the fourth surface 15 includes the rake surface in the present non-limiting aspect of the disclosure. Alternatively, a part of the third surface 13 may be the flank surface, or the entirety of the third surface 13 may be the flank surface. At least a region along the first cutting edge 17 serves as the flank surface in the present non-limiting aspect of the disclosure. Alternatively, a part of the fourth surface 15 may be the rake surface, or the entirety of the fourth surface 15 may be the rake surface. At least a region along the first cutting edge 17 serves as the rake surface in the present non-limiting aspect of the disclosure.

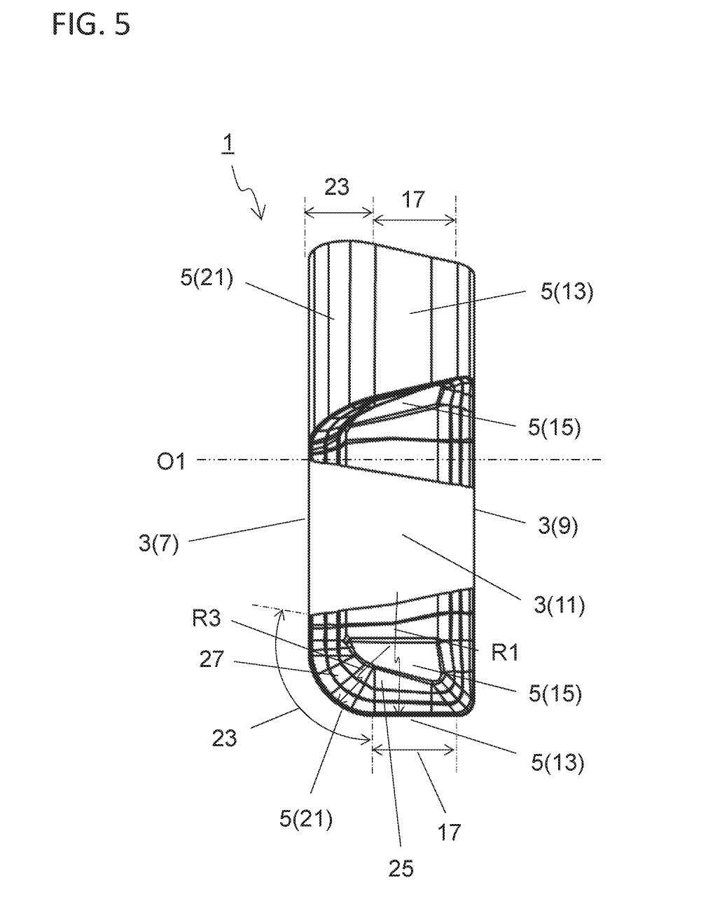

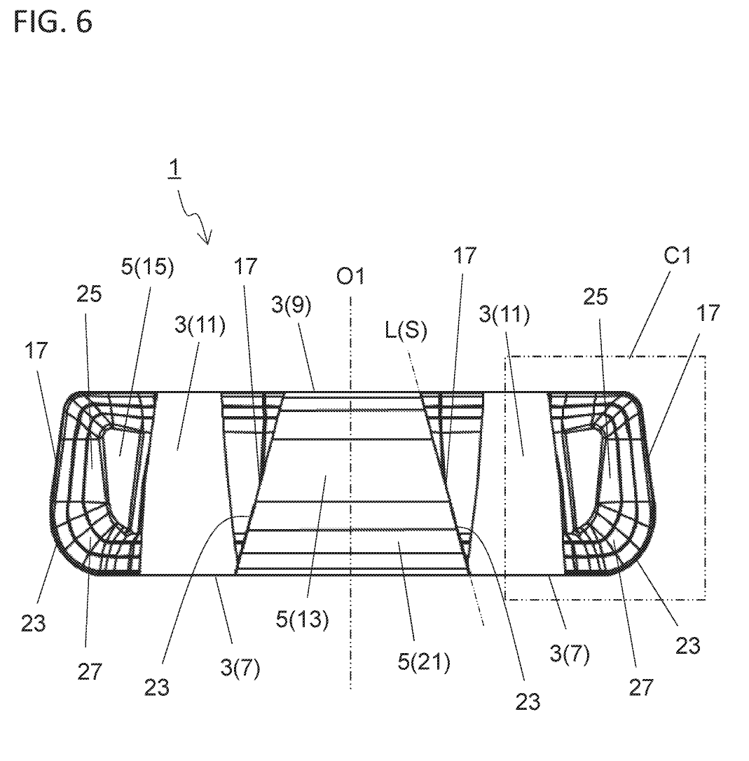

As illustrated in FIGS. 5 and 6, the first cutting edge 17 in the present non-limiting aspect of the disclosure is inclined relative to the central axis O1 in a front view of the third surface 13, specifically, as viewed toward the flank surface. This ensures that the first cutting edge 17 gradually comes into contact with a workpiece. It is therefore possible to reduce cutting resistance exerted on the first cutting edge 17. It is also possible to delay timing at which the first cutting edge 17 comes into contact with the workpiece, consequently leading to less influence of chatter vibration or the like. Specifically, the first cutting edge 17 in the present non-limiting aspect of the disclosure is inclined so as to approach the central axis O1 as going from an end portion at a side of the first surface 7 toward an end portion at a side of the second surface 9.

The first cutting edge 17 in the present non-limiting aspect of the disclosure has a convex curvilinear shape in a front view of the fourth surface 15, specifically, as viewed toward the rake surface. The first cutting edge 17 also has a gentle convex curvilinear shape being somewhat projected outward in FIGS. 5 and 6. Thus, the first cutting edge 17 does not have a simple straight-line shape but the convex curvilinear shape. A bottom surface of a groove formed by a slot processing is therefore less likely to protrude in a convex shape, thereby making it easier to bring the bottom surface of the groove closer to flat.

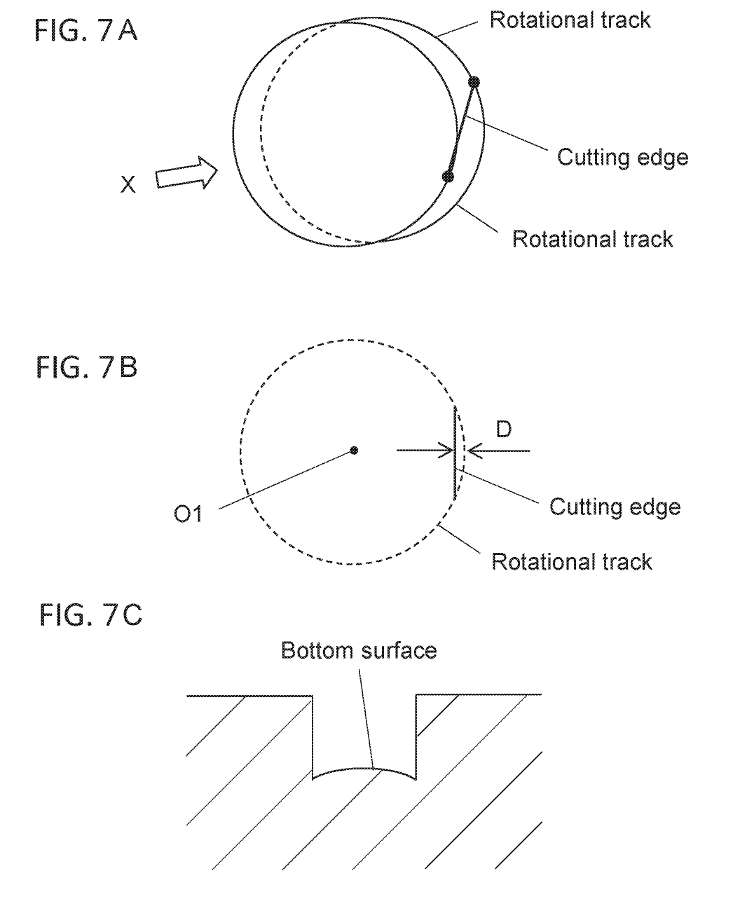

For example, when a cutting edge has a simple straight-line shape, a middle part of the straight-line shaped cutting edge is located closer to the central axis O1 by an amount equal to a distance D than rotational tracks at both end portions of the straight-line shaped cutting edge as illustrated in FIGS. 7A and 7B. Consequently, the groove formed by the slot processing has such a shape that the bottom surface thereof is protruded in the convex shape as illustrated in FIG. 7C.

In FIG. 7A, the straight-line shaped cutting edge is indicated by a thick straight-line, and both end portions of the straight-line shaped cutting edge are indicated by black circles. FIG. 7A illustrates the straight-line shaped cutting edge and the rotational tracks of both end portions of the cutting edge. FIG. 7B is a diagram when FIG. 7A is viewed from an arrow X direction parallel to the rotation axis, in which the cutting edge is indicated by a solid line and the rotational tracks of both end portions of the cutting edge are indicated by a broken line. FIG. 7C illustrates a cross section of a machined groove obtained when the slot processing is carried out using the straight-line shaped cutting edge.

The bottom surface of the groove is protruded in the convex shape when the cutting edge has the straight-line shaped as described above. However, with the insert 1 of the present non-limiting aspect of the disclosure, the bottom surface of the groove is less likely to protrude because the first cutting edge 17 has the convex curvilinear shape as viewed toward the rake surface. In other words, it is possible to carry out a highly accurate grooving process. Although the first cutting edge 7 looks like a straight-line shape in FIG. 5 because a radius of curvature R1 has a large value, the first cutting edge 7 in the present non-limiting aspect of the disclosure has the convex curvilinear shape in the front view of the fourth surface 15.

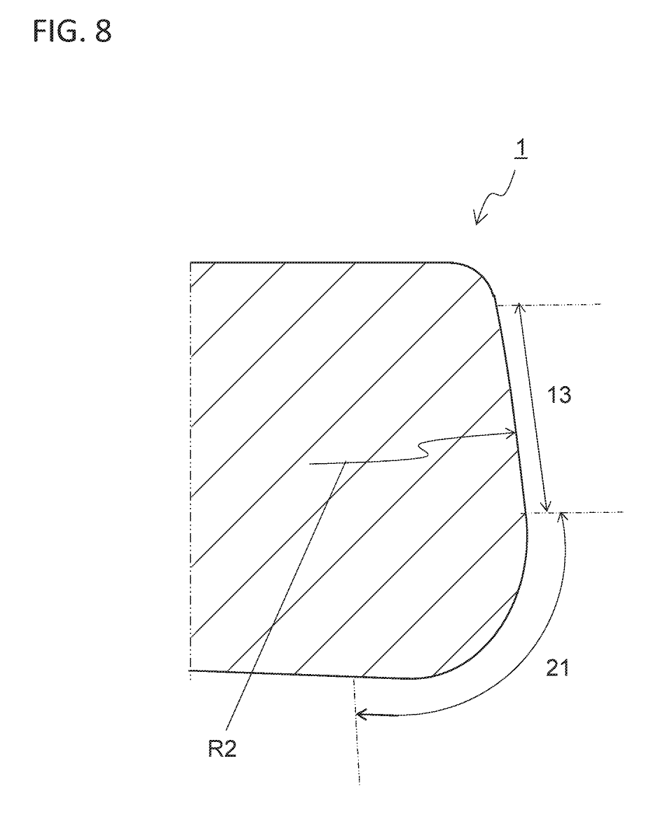

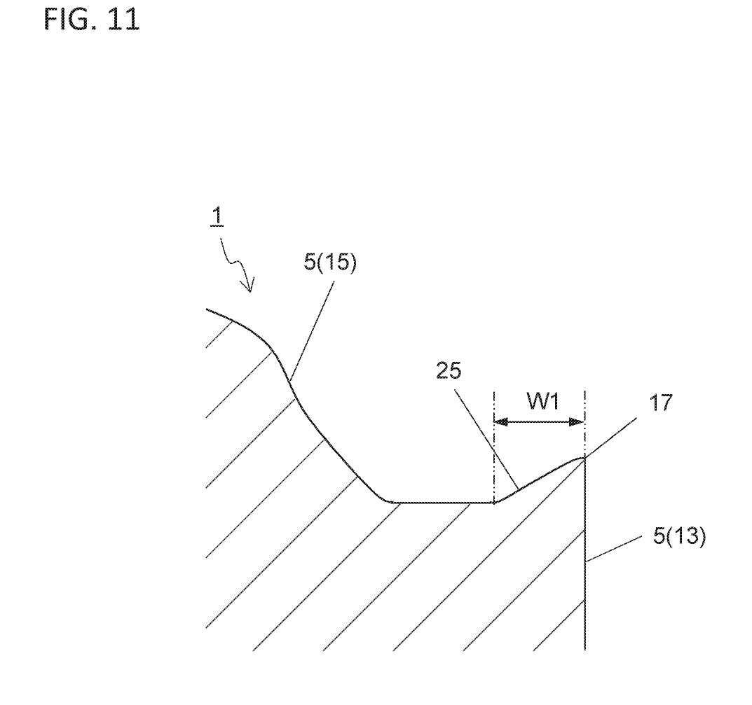

The third surface 13 may not have a flat surface shape but a curved shape because the first cutting edge 17 has the convex curvilinear shape as described above. Specifically, the third surface 13 may not have a straight-line shape but a convex curvilinear shape in a cross section including the central axis O1 illustrated in FIG. 8. Although the third surface 13 looks like a straight-line shape in FIG. 8 because a radius of curvature R2 has a large value, the third surface 13 illustrated in FIG. 8 has the convex curvilinear shape. The third surface 13 has a straight-line shape in a cross section orthogonal to the central axis O1 as illustrated in FIG. 11.

The shape of the third surface 13 is not limited to the above-mentioned shape. For example, the third surface 13 may not have the straight-line shape but an outwardly swelled shape in the cross section orthogonal to the central axis O1. This makes it possible to enhance the strength of the second part 5 against a cutting load exerted on the first cutting edge 17.

The second part 5 may include a fifth surface 21 in addition to the third surface 13 and the fourth surface 15. Alternatively, the second part 5 may also include a second cutting edge 23 in addition to the first cutting edge 17.

The fifth surface 21 is located between the third surface 13 and the first surface 7 in the first part 3. Although different surfaces may be respectively located between the third surface 13 and the fifth surface 21, and between the first part 3 and the fifth surface 21, the fifth surface 21 connects to each of the third surface 13 and the first surface 7 in the present non-limiting aspect of the disclosure.

Similarly to the third surface 13, the fifth surface 21 may not a straight-line shape but a convex curvilinear shape in a cross section including the central axis O1. Alternatively, the fifth surface 21 may have a straight-line shape in a cross section orthogonal to the central axis O1. The strength of the second part 5 against a cutting load exerted on the second cutting edge 23 can be enhanced when the fifth surface 21 has the straight-line shape in the cross section orthogonal to the central axis O1.

The second cutting edge 23 is located along at least a part of an intersection part of the fifth surface 21 and the fourth surface 15. When the fifth surface 21 has a convex curved surface shape, the second cutting edge 23 has a convex curvilinear shape in a front view of a rake surface, specifically, as viewed toward a side of the fourth surface 15. The second cutting edge 23 is generally called a corner cutting edge.

The fifth surface 21 serves as a flank surface when the fourth surface 15 has a rake surface in the present non-limiting aspect of the disclosure. At least a region along the second cutting edge 23 on the fifth surface 21 serves as a flank surface in the present non-limiting aspect of the disclosure.

Similarly to the first cutting edge 17, the second cutting edge 23 may be inclined in a front view of the flank surface, specifically, as viewed toward the fifth surface 21. When the second cutting edge 23 is inclined as described above, the second cutting edge 23 gradually comes into contact with a workpiece, and it is therefore possible to reduce cutting resistance exerted on the second cutting edge 23 as in the case of the first cutting edge 17. Moreover, when the second cutting edge 23 has the convex curvilinear shape as described above, it is possible to avoid load concentration on the second cutting edge 23 which is located at an end portion on the cutting edge and functions as the corner cutting edge. This leads to enhanced durability of the second cutting edge 23. The second cutting edge 23 illustrated in FIG. 5 has the convex curvilinear shape even though the second cutting edge 23 looks like a straight-line shape because of a large value of the radius of curvature R3.

When the first cutting edge 17 and the second cutting edge 23 have the convex curvilinear shape as viewed toward the fourth surface 15, the radius of curvature R3 of the second cutting edge 23 may be smaller than the radius of curvature R1 of the first cutting edge 17 as viewed toward the fourth surface 15. When the radius of curvature R3 of the second cutting edge 23 is relatively small, the durability of the second cutting edge 23 can be enhanced without excessively increasing a width of a groove to be machined.

The first cutting edge 17 in the present non-limiting aspect of the disclosure is inclined relative to the central axis O1 as viewed toward the third surface 13. The second cutting edge 23 connects to one of both end portions of the first cutting edge 17 which is more away from the central axis O1. Accordingly, the second cutting edge 23 is more away from the central axis O1 than the first cutting edge 17 as viewed from a side of the third surface 13.

When the second cutting edge 23 connects to the first cutting edge 17 as described above, the second cutting edge 23 that functions as the corner cutting edge comes into contact with the workpiece before the first cutting edge 17 in the grooving process. This leads to a reduction in chatter vibration, thereby enhancing the durability of the cutting edges.

As apparent from the fact that the first cutting edge 17 and the second cutting edge 23 are located on an imaginary straight-line L in FIG. 6, the first cutting edge 17 and the second cutting edge 23 may be located on an imaginary plane S in the present non-limiting aspect of the disclosure. When the first cutting edge 17 and the second cutting edge 23 are so located, it is easy to avoid cutting load concentration at a specific location of each of the first cutting edge 17 and the second cutting edge 23. This leads to enhanced durability of the cutting edges.

Alternatively, at least a part of the fifth surface 21 may protrude more than the first surface 7 in a direction away from the second surface 9. In other words, at least a part of the second cutting edge 23 may protrude more than the first surface 7 in the direction away from the second surface 9. When the second cutting edge 23 and the fifth surface 21 are located as described above, the first surface 7 is less likely to come into contact with a surface of the groove during the grooving process. This leads to enhanced durability of the first part 3 and enhanced smoothness of the surface of the groove.

The fourth surface 15 in the present non-limiting aspect of the disclosure includes a rake surface, specifically, a first rake surface 25 located along the first cutting edge 17, and a second rake surface 27 located along the second cutting edge 23. This ensures that chips generated by the first cutting edges 17 and the second cutting edge 23 are respectively curled and suitably discharged to the outside.

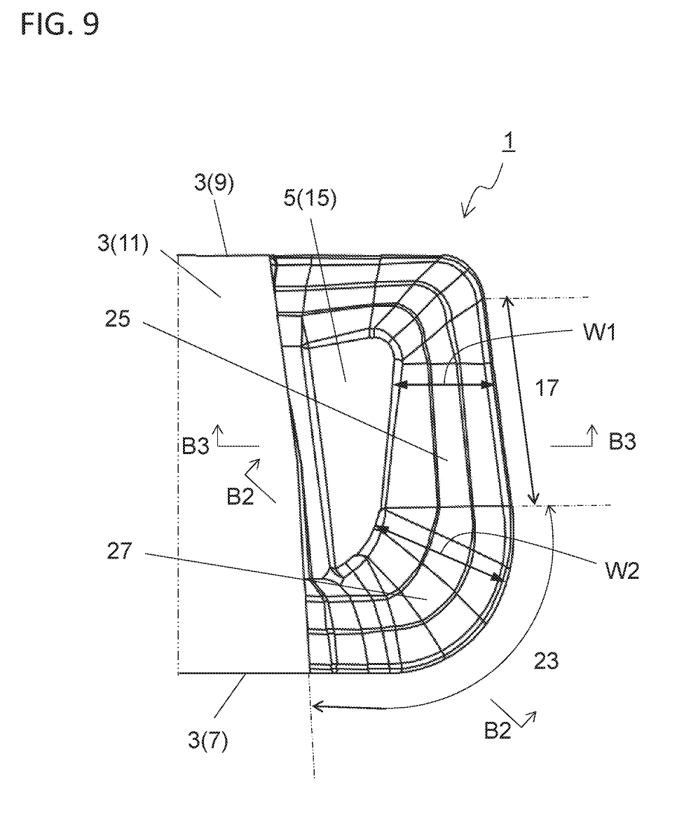

Here, as illustrated in FIG. 9, a width W1 of the first rake surface 25 may decrease as going away from the second rake surface 27 as viewed from a side of the fourth surface 15. When the first rake surface 25 includes the above configuration, chips, which are generated by the first cutting edge 17 and flow along the first rake surface 25, are easy to flow in a direction away from the second rake surface 27. The chips flowing along the first rake surface 25 are therefore less likely to collide with the chips flowing along the second rake surface 27. Consequently, chip clogging is less likely to occur.

For a similar reason, a width W2 of the second rake surface 27 may decrease as going away from the first rake surface 25 as viewed from a side of the fourth surface 15 in the present non-limiting aspect of the disclosure. When the second rake surface 27 includes the above configuration, chips, which are generated by the second cutting edge 23 and flow along the second rake surface 27, are easy to flow in a direction away from the first rake surface 25, and chip clogging is therefore less likely to occur.

<Cutting Tool>

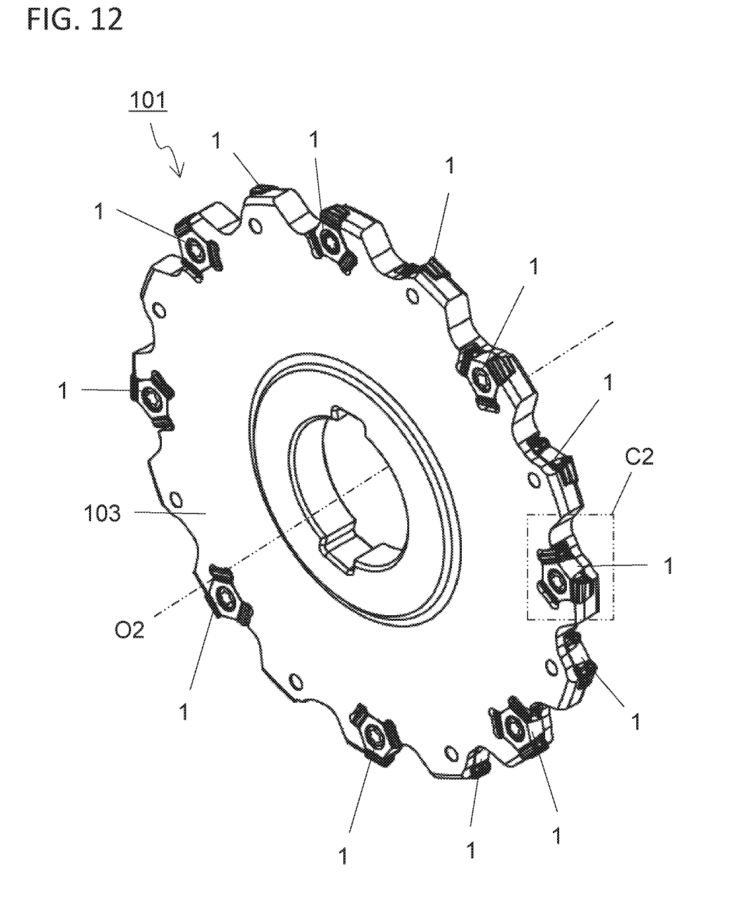

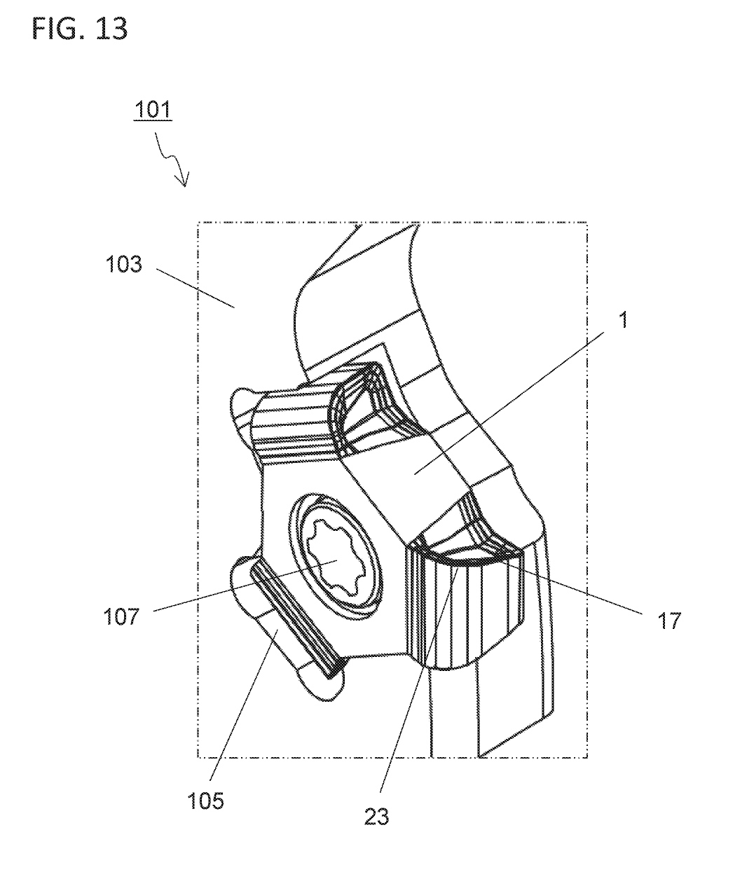

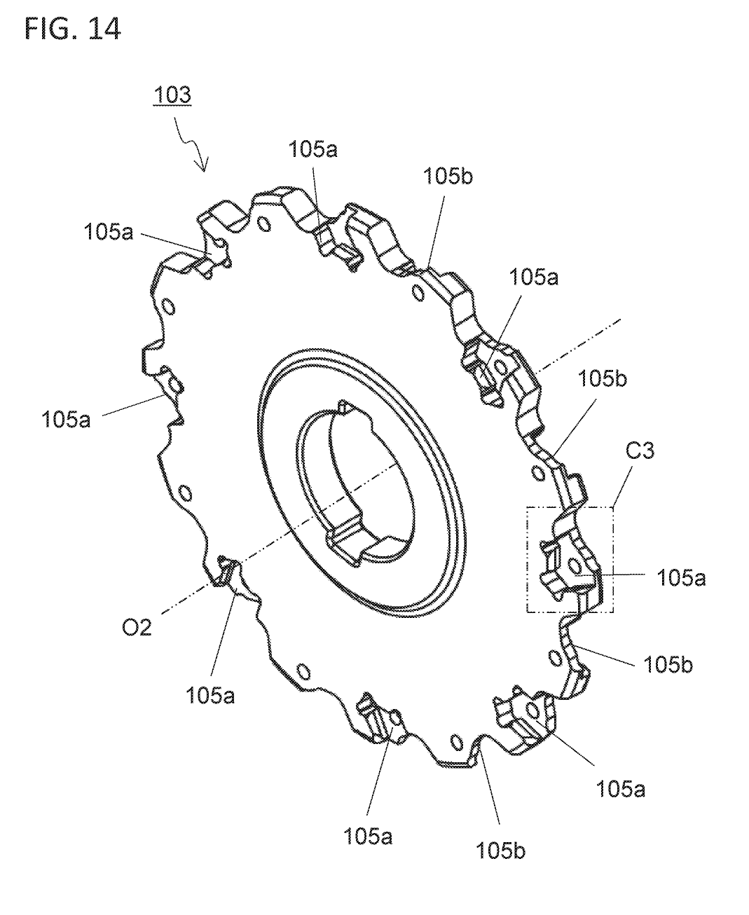

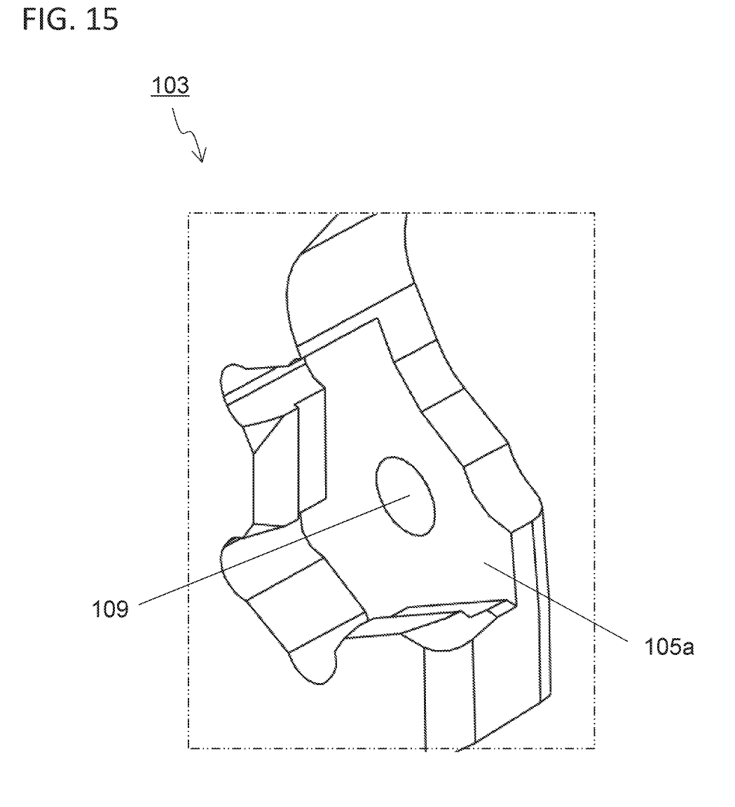

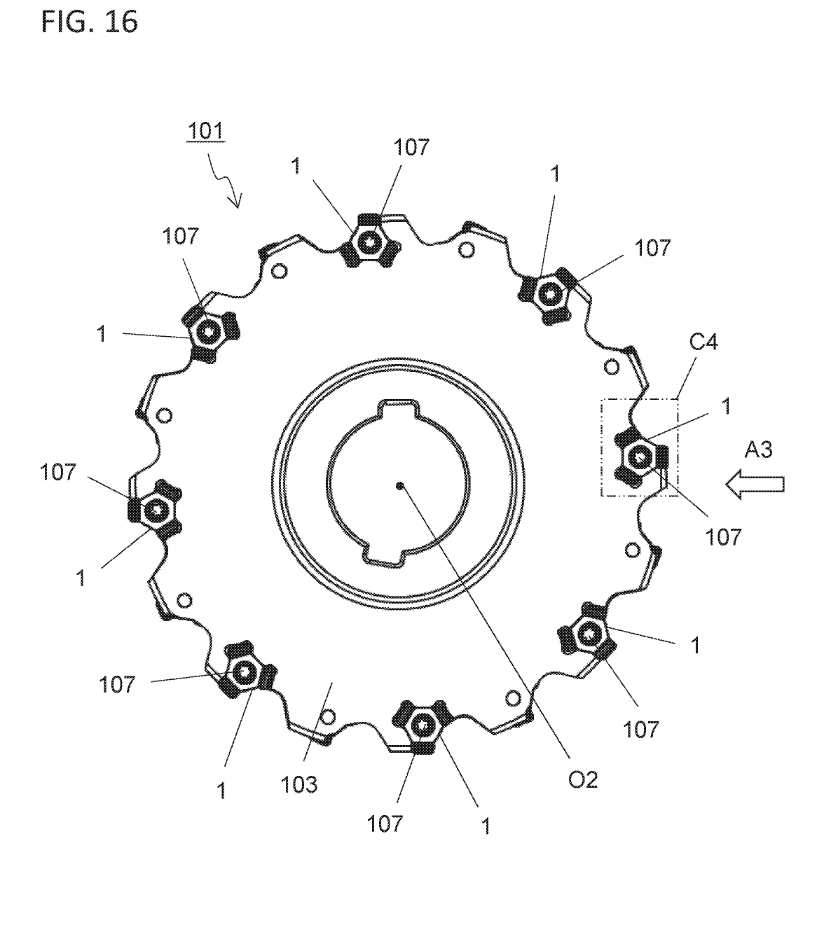

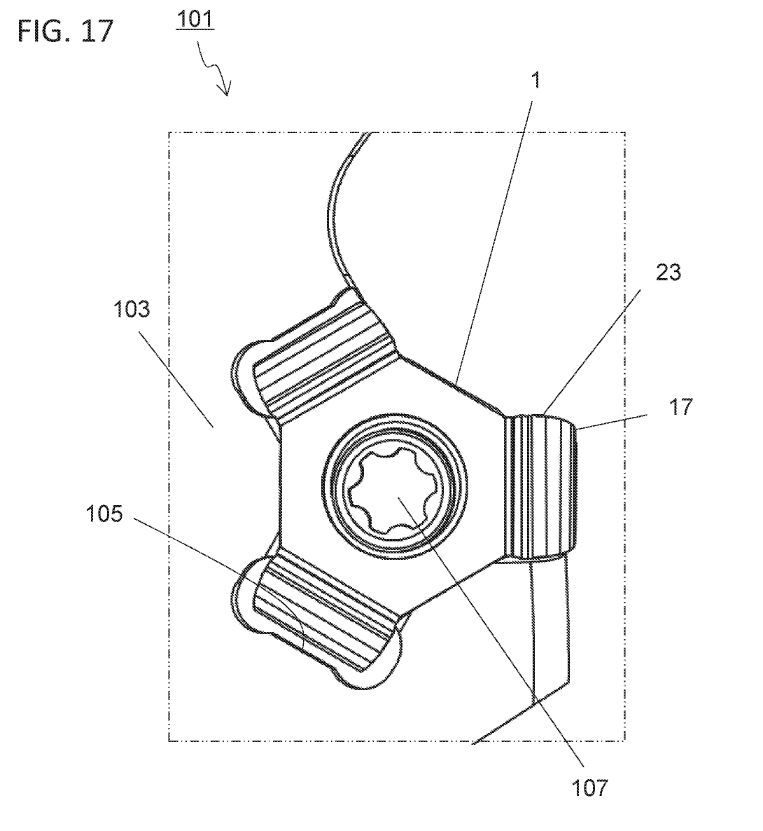

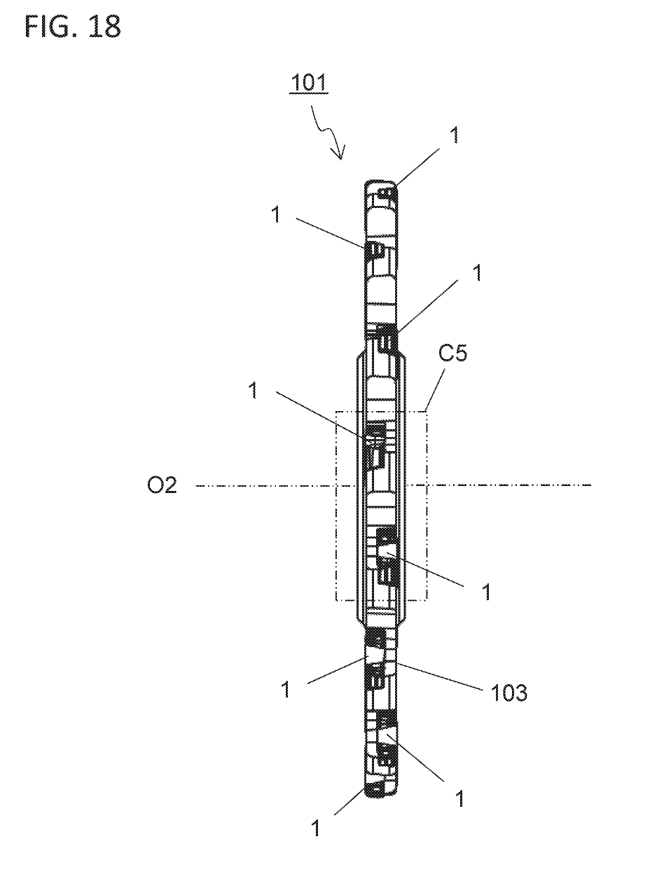

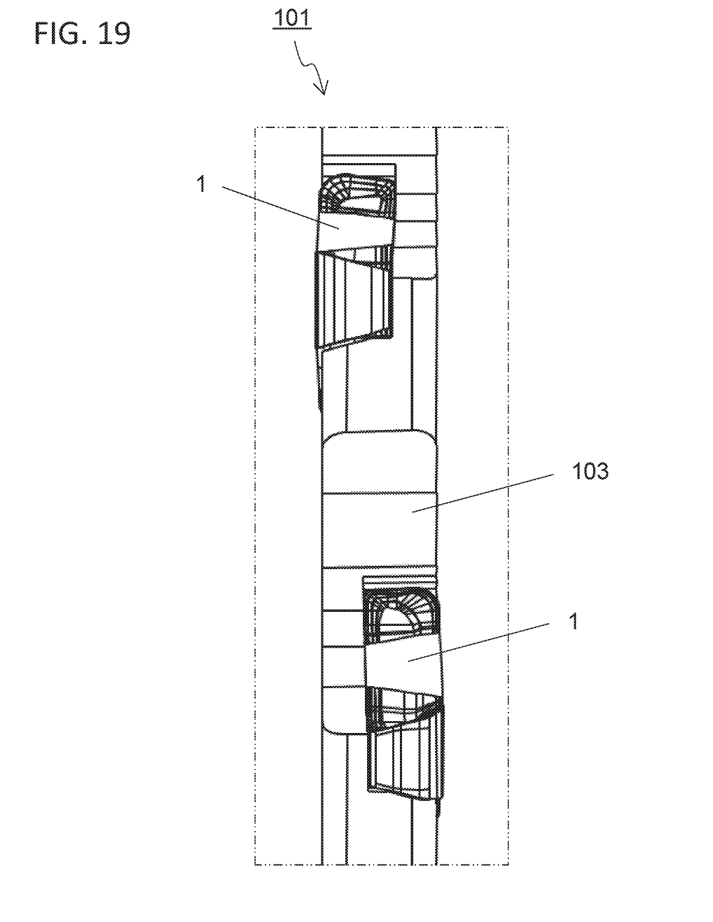

A cutting tool 101 in a non-limiting aspect of the disclosure is described below with reference to FIGS. 12 to 19. FIGS. 12 and 13 and FIGS. 16 to 19 illustrate a state in which the insert 1 is attached to a pocket 105 of a holder 103 by a screw 107. FIGS. 14 and 15 illustrate the holder 103 from which the insert 1 is detached. A two-dot chain line in FIG. 12 or the like indicates a rotation axis O2 of the cutting tool 101.

The cutting tool 101 of the present non-limiting aspect of the disclosure includes the insert 1, the holder 103, and the screw 107. The cutting tool 101 of the present non-limiting aspect of the disclosure is a tool used for a milling process for forming a fine groove. The holder 103 has a disk shape with a small thickness, and includes the rotation axis O2 extending in a direction orthogonal to a planar part.

The pocket 105 designed to receive the insert 1 is disposed at an outer peripheral part of the disk shaped holder 103. Specifically, the cutting tool 101 of the present non-limiting aspect of the disclosure includes the holder 103 including the pocket 105 located at an outer peripheral part thereof, and the insert 1 located at the pocket 105. The holder 103 includes a plurality of the pockets 105 in the present non-limiting aspect of the disclosure. The insert 1 is attached to each of the pockets 105. That is, the cutting tool 101 of the present non-limiting aspect of the disclosure includes a plurality of the inserts 1.

The plurality of pockets 105 in the present non-limiting aspect of the disclosure are made up of a first pocket 105a and a second pocket 105b. The first pocket 105a is located at an outer peripheral side of one major surface in the holder 103. The second pocket 105b is located at an outer peripheral side of the other major surface in the holder 103. Although the holder 103 in the present non-limiting aspect of the disclosure includes a plurality of the first pockets 105a and a plurality of the second pockets 105b, the holder 103 may include only one first pocket 105a and only one second pocket 105b.

Each of the inserts 1 is attached to the pocket 105 so that the first cutting edge and the second cutting edge protrude more outward than an outer peripheral surface of the holder 103. The insert is attached to each of the first pockets 105a and the second pockets 105b so that the second main surface comes into contact therewith.

The holder 103 in the present non-limiting aspect of the disclosure is provided with a screw hole 109 corresponding to the through hole of the insert 1. The insert 1 is fixed to the pocket 105 by the screw 107 in the present non-limiting aspect of the disclosure. Specifically, the insert 1 is fixable to the holder 103 by inserting a front end of the screw 107 into the screw hole 109 formed in the pocket 105, and by fixing the screw 107 to the screw hole 109.

For example, steel and cast iron are usable as a material of the holder 103. Of these materials, high rigidity steel may be used in a non-limiting aspect of the disclosure.

<Method of Manufacturing Machined Product>

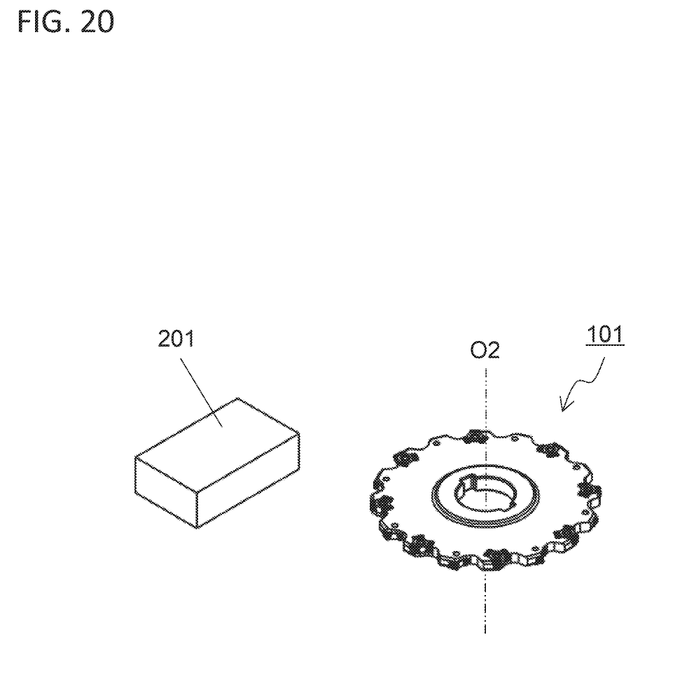

A method of manufacturing a machined product is described below with reference to FIGS. 20 to 22. FIGS. 20 to 22 illustrate the method of manufacturing a machined product. A two-dot chain line in FIGS. 20 to 22 indicates the rotation axis O2 of the cutting tool. The machined product is manufacturable by carrying out a cutting process of a workpiece 201. A cutting method in the present non-limiting aspect of the disclosure includes the following steps:

(1) rotating the cutting tool 101 described above;

(2) bringing the insert 1 in the cutting tool 101 being rotated into contact with the workpiece 201; and

(3) moving the cutting tool 101 away from the workpiece 201.

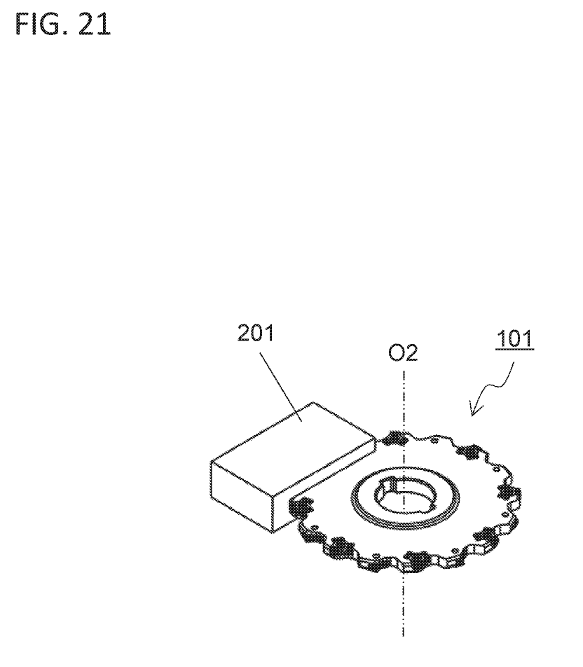

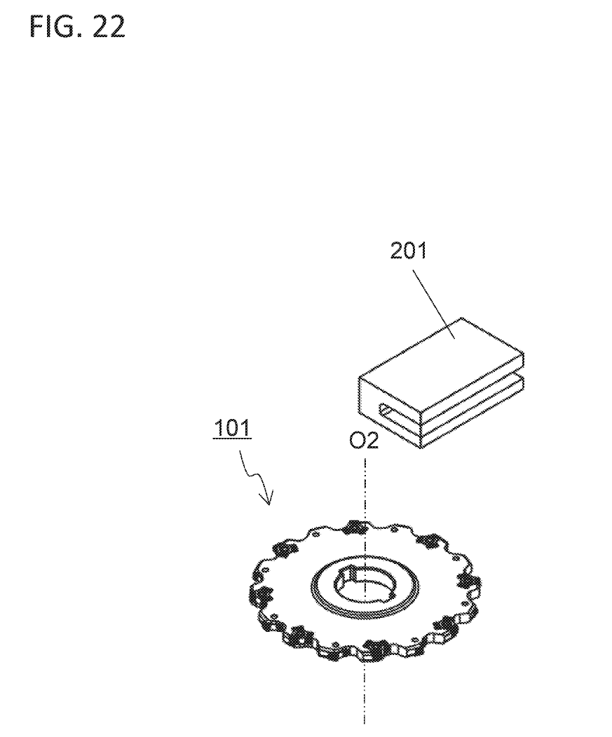

More specifically, firstly, the cutting tool 101 is brought relatively near the workpiece 201 while rotating the cutting tool 101 around the rotation axis O2 as illustrated in FIG. 20. Then, the workpiece 201 is cut out by bringing the cutting tool 101 into contact with the workpiece 201 as illustrated in FIG. 21. The first cutting edge and the second cutting edge are brought into contact with the workpiece 201 in the present non-limiting aspect of the disclosure. Thereafter, the cutting tool 101 is moved relatively away from the workpiece 201 as illustrated in FIG. 22.

FIGS. 20 to 22 illustrate a non-limiting aspect of the disclosure in which the workpiece 201 is fixed and the cutting tool 101 is rotated around the rotation axis. Specifically, the workpiece 201 is fixed and the cutting tool 101 is brought near in FIG. 20. FIG. 22 illustrates a non-limiting aspect of the disclosure in which the cutting tool 101 is moved away from the workpiece 201.

Although the foregoing has described an aspect of the disclosure in which the workpiece 201 is fixed and the cutting tool 101 is moved in each of the steps, it is, of course, not intended to limit to this aspect of the disclosure.

For example, in the step (1), the workpiece 201 may be brought near the cutting tool 101. Similarly, in the step (3), the workpiece 201 may be moved away from the cutting tool 101. When the cutting process is continued, it is necessary to repeat the step of bringing the first cutting edge and the second cutting edge of the insert 1 into contact with different portions of the workpiece 201, while keeping the cutting tool 101 rotated. When the first cutting edge and the second cutting edge which are in use are worn out, the first cutting edge and the second cutting edge which are not used need to be used by turning the insert 1 120° around the central axis of the through hole. A representative example of the material of the workpiece 201 is carbon steel, alloy steel, stainless steel, cast iron, or non-ferrous metal.

Although the foregoing non-limiting aspects of the disclosure have illustrated, as the cutting tool 101, the tool used for the milling process for forming the fine groove, the cutting tool 101, for which the insert 1 of the present non-limiting aspect of the disclosure is used, the disclosure is not limited to the above tool. For example, the insert 1 of the present non-limiting aspect of the disclosure may be used for a turning tool for grooving.

### DESCRIPTION OF THE REFERENCE NUMERALS

1 insert
2 first part
5 second part
7 first surface
9 second surface
11 side surface
13 third surface
15 fourth surface
17 first cutting edge
19 through hole
21 fifth surface
23 second cutting edge
25 first rake surface
27 second rake surface
101 cutting tool
103 holder
105 pocket
105a first pocket
105b second pocket
107 screw
109 screw hole
201 workpiece

1. An insert for a cutting tool, comprising:
a first part and a second part, wherein
the first part comprises
a first surface,
a second surface located at an opposite side of the first surface, and
a plurality of side surfaces located between the first surface and the second surface,
the second part comprises
a third surface located between the plurality of side surfaces and located from a side of the first surface to a side of the second surface,
a fourth surface which is located between the plurality of side surfaces and adjacent to the third surface, and
a first cutting edge located along at least a part of a ridge line of the third surface and the fourth surface,
the first cutting edge is inclined to approach a center of the second surface going toward an end portion at a side of the second surface in a front view of the third surface, and
the first cutting edge has a convex curvilinear shape in a front view of the fourth surface.

2. The insert according to claim 1, wherein
the first part comprises a central axis passing through a center of the first surface and a center of the second surface,
the third surface has a convex curvilinear shape in a cross section including the central axis, and
the third surface has a straight-line shape in a cross section orthogonal to the central axis.

3. The insert according to claim 1, wherein
the second part further comprises
a fifth surface located between the third surface and the first surface, and
a second cutting edge located along at least a part of a ridge line of the fifth surface and the fourth surface,
the second cutting edge is inclined to approach a center of the first surface going toward an end portion at a side of the first surface in a front view of the fifth surface, and
the second cutting edge has a convex curvilinear shape in a front view of the fourth surface.

4. The insert according to claim 3, wherein
a radius of curvature of the second cutting edge is smaller than a radius of curvature of the first cutting edge in a front view of the fourth surface.

5. The insert according to claim 3, wherein
the second cutting edge is more away than the first cutting edge from a central axis passing through a center of the first surface and a center of the second surface in a front view of the third surface.

6. The insert according to claim 3, wherein
the first cutting edge and the second cutting edge are located on an imaginary plane.

7. The insert according to claim 3, wherein
at least a part of the fifth surface protrudes more than the first surface in a direction away from the second surface.

8. The insert according to claim 3, wherein
the fourth surface comprises
a first rake surface located along the first cutting edge, and
a second rake surface located along the second cutting edge, and
a width of the first rake surface becomes smaller going away from the second rake surface in a front view of the fourth surface.

9. The insert according to claim 8, wherein
a width of the second rake surface becomes smaller going away from the first rake surface in a front view of the fourth surface.
